(19) United States
(12) Patent Application Publication
(10) Pub. No.: US 2025/0180703 A1
(43) Pub. Date: Jun. 5, 2025

(54) Non-Interfering Coherent Lidar System

(71) Applicant: The Boeing Company, Arlington, VA (US)

(72) Inventors: Nathan D. Hiller, Irvine, CA (US); Robert Michael Dowgwillo, St. Louis, MO (US)

(21) Appl. No.: 18/528,432

(22) Filed: Dec. 4, 2023

(51) Int. Cl. G01S 7/481; G01S 7/48; G01S 17/933

(52) U.S. Cl. CPC G01S 7/4811; G01S 7/4802; G01S 17/933

(57) ABSTRACT

A vehicle lidar network comprising vehicles and lidar systems in the vehicles. The lidar systems are configured to emit laser beams having a number of electromagnetic properties in which the number of electromagnetic properties is selected to reduce interference caused by the laser beams emitted from other lidar systems.

### BACKGROUND INFORMATION

### 1. Field

The present disclosure relates generally to lidar systems and in particular to operating vehicles using lidar systems without interference from other lidar systems.

### 2. Background

Light detection and ranging (lidar) systems are laser-based sensor systems that can be used in aircraft as sensor systems. Lidar systems can be used to replace currently-used sensors and add new capabilities for future aircraft. Many currently-used sensors protrude from the skin of the aircraft, making these sensors susceptible to environmental conditions. These conditions include ice, insects, birds, and other conditions that can damage or reduce the effectiveness of these currently-used sensors.

Lidar systems can be used in aircraft to measure parameters for the current state of the aircraft. These parameters include, for example, true airspeed, angle-of-sideslip, angle-of-attack, outside air temperature and pressure, and cloud density. Further, lidar systems can also be used to predict the future state of parameters for the aircraft. For example, clear air turbulence that is miles ahead of the aircraft can be detected using a lidar system.

Lidar systems generate sensor data by emitting a laser beam into the atmosphere and by detecting backscatter caused by the laser beam encountering particles in the atmosphere. The particles can be air molecules, aerosols, or both. The aerosols can be comprised of dust, ice crystals, water droplets, or other small particles. The sensor data can also be generated from the laser beam encountering an object such as a vehicle, a bird, or other object.

### SUMMARY

An embodiment of the present disclosure provides a vehicle lidar network comprising vehicles and lidar systems in the vehicles. The lidar systems are configured to emit laser beams having a number of electromagnetic properties in which the number of electromagnetic properties is selected to reduce interference caused by other laser beams emitted from other lidar systems.

Another embodiment of the present disclosure provides a platform lidar network comprising platforms; and lidar systems in the platforms. The lidar systems are configured to emit laser beams having a number of electromagnetic properties in which the number of electromagnetic properties is selected to reduce interference caused by other laser beams emitted from other lidar systems.

Yet another embodiment of the present disclosure provides a vehicle sensor network comprises vehicles and electromagnetic sensor systems in the vehicles. The electromagnetic sensor systems are configured to emit electromagnetic waves having a number of electromagnetic properties in which the number of electromagnetic properties is selected to reduce interference caused by other electromagnetic waves emitted from other electromagnetic sensor systems.

Still another embodiment of the present disclosure provides a method of operating a vehicle lidar network. Vehicles are identified in a region. A number of electromagnetic properties is determined for laser beams emitted by lidar systems in the vehicles. The number of electromagnetic properties for the lidar system is changed to reduce the interference from the other lidar systems.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a lidar environment in accordance with an illustrative embodiment;

FIG. 3 is an illustration of a block diagram of a vehicle sensor network in accordance with an illustrative embodiment;

FIG. 4 is an illustration of aircraft with lidar systems in points with an illustrative embodiment;

FIGS. 5A and 5B are illustrations of channels for laser beam wavelength in accordance with an illustrative item;

FIG. 6 is an illustration of a flowchart of a process for operating a lidar network in accordance with an illustrative embodiment;

FIG. 7 is an illustration of a flowchart of a process for operating a lidar network in accordance with an illustrative embodiment;

FIG. 8 is an illustration of a flowchart of a process for operating a vehicle lidar network in accordance with an illustrative embodiment;

FIG. 9 is an illustration of a flowchart of a process for selecting electromagnetic properties in accordance with an illustrative embodiment;

FIG. 10 is an illustration of a flowchart of a process for changing a laser beam orientation in accordance with an illustrative embodiment;

FIG. 11 is an illustration of a flowchart of a process for changing a number of electromagnetic properties in accordance with an illustrative embodiment;

FIG. 12 is an illustration of a flowchart of a process for changing a number of electromagnetic properties in accordance with an illustrative embodiment;

FIG. 13 is an illustration of a flowchart of a process for changing a number of electromagnetic properties in accordance with an illustrative embodiment;

FIG. 14 is an illustration of a flowchart of a process for changing a number of electromagnetic properties in accordance with an illustrative embodiment;

FIG. 15 is an illustration of a flowchart of a process for changing a number of electromagnetic properties in accordance with an illustrative embodiment;

FIG. 16 is an illustration of a block diagram of a data processing system in accordance with an illustrative embodiment;

FIG. 17 is an illustration of a block diagram of an aircraft manufacturing and service method in accordance with an illustrative embodiment; and

FIG. 18 is an illustration of a block diagram of an aircraft in which an illustrative embodiment may be implemented.

### DETAILED DESCRIPTION

The illustrative embodiments recognize and take into account one or more different considerations as described herein. For example, a laser beam emitted from a lidar system for a first aircraft hits the lidar system for another aircraft. The emitted laser beam from the first aircraft has a much greater intensity than backscatter detected from the laser beam of the other aircraft. The emitted laser beam has a much greater intensity than backscatter light even after traveling hundreds of kilometers. Further, the emitted laser beam can also widen or expand, increasing the chance that the laser beam is detected by the lidar system of the other aircraft. This situation can cause the generation of erroneous sensor data. In essence, the emitted laser beam can blind the lidar system in another aircraft.

In the illustrative examples, this issue can be reduced by having the different lidar systems in different aircraft use wavelengths that are unique to those aircraft. For example, a fleet of aircraft or a plurality of aircraft operating in a particular region can have lidar systems that are selected such that duplication of wavelengths is absent or very low.

For example, with 100 aircraft where each has a lidar system, 100 different wavelengths would avoid the issue of erroneous sensor data being caused by interference from other lidar systems. If two or three of the 100 aircraft use the same wavelength, then the chances of generating erroneous sensor data is much less as compared to all 100 aircraft using the same wavelength in their lidar systems.

Thus, the illustrative embodiments provide a method, apparatus, system, and computer program product for operating a lidar network, such as a vehicle lidar network. In one illustrative example, a vehicle lidar network comprises vehicles and lidar systems in the vehicles. The lidar systems are configured to emit laser beams having a number of electromagnetic properties in which the number of electromagnetic properties is selected to reduce interference caused by the laser beams emitted from other lidar systems in detecting backscatter light.

In one illustrative example, the vehicle lidar system can be preconfigured prior to operation of the vehicle. In another illustrative example, the vehicle lidar network can be dynamically configured during operation of the vehicles.

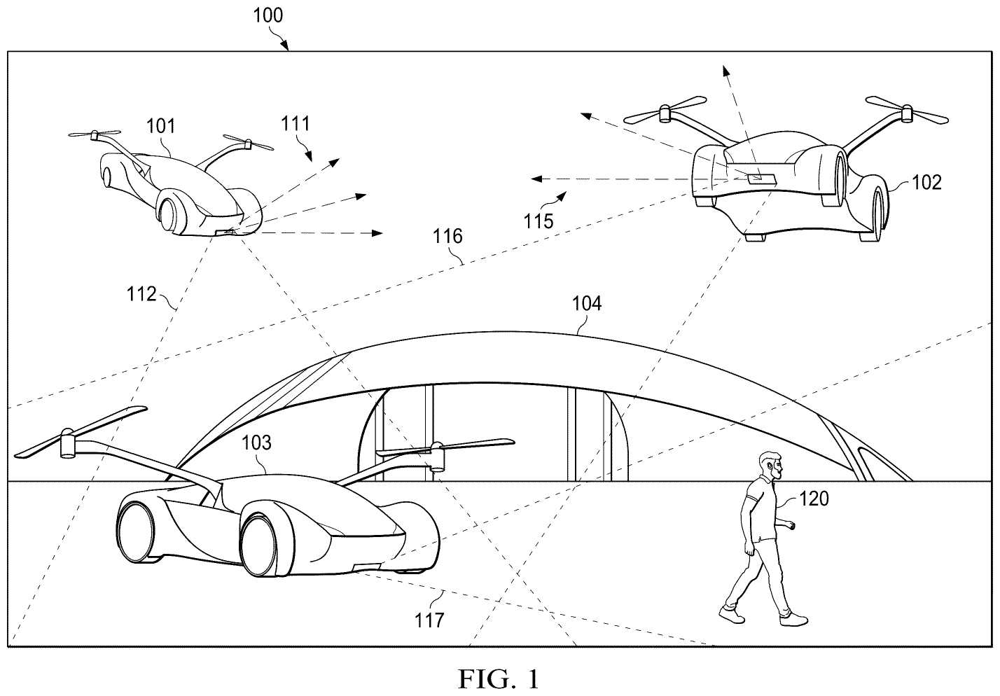

With reference now to the figures, and in particular, with reference to FIG. 1, a pictorial representation of a network of data processing systems is depicted in which illustrative embodiments may be implemented. Vehicle lidar network 100 comprises vehicles with lidar systems. As depicted in this example, vehicle lidar network 100 comprises air-land vehicles in the form of flying car 101, flying car 102, and flying car 103. These flying cars are located at vertiport 104. In this example, flying car 101, flying car 102, and flying car 103 can operate both on the ground and in the air. As depicted in this example, flying car 103 is operating on the ground. Flying car 101 and flying car 102 are flying in the air.

The operations of these flying cars are facilitated using sensor systems such as lidar systems located in these flying cars. In this illustrative example, the lidar systems in the flying cars are used in operating these flying vehicles.

The lidar systems can be used to generate sensor data. The sensor data can include optical air data and object data. In this example, optical air data includes a number of parameters such as air speed, density, temperature, and clear air turbulence. Object data is data that can be used for object detection. This sensor data can be used to determine various parameters such as speed, the presence of objects, and other information.

As used herein, “a number of,” when used with reference to items means one or more items. For example, “a number of parameters” is one or more parameters.

In this illustrative example, lidar systems in the air vehicles can be configured to use different wavelengths. The use of a different wavelength for a lidar system in a flying car from the wavelengths for other lidar systems in other flying cars can avoid at least one of interference or the generation of erroneous data.

For example, flying car 101 emits narrow laser beams 111 in the direction of flying car 102. If both flying car 101 and flying car 102 have lidar systems that use the same wavelength, the lidar system of flying car 102 can detect one or more narrow laser beams 111, in addition to backscatter light generated from emitting narrow laser beams 115. As a result, erroneous optical air data can be generated. For example, flying car 102 can generate an erroneous air speed using light detected from one or more of narrow laser beams 111.

In the illustrative example, the lidar systems in flying car 101, flying car 102, and flying car 103 can use different wavelengths in the generation of optical air data or object data resulting from detecting light from laser beams emitted from other flying cars.

In this illustrative example, the lidar systems in the flying cars can be reconfigured to have selected wavelengths for the laser beams. In other illustrative examples, one or more of the wavelengths of laser beams emitted from the lidar systems in the flying cars in this example can be changed during operation of the flying cars to avoid interference in generating optical air data and object data.

In this depicted example, narrow laser beams are used to generate optical air data. Broad laser beams are used to generate object data. The difference between a narrow laser beam and a broad laser beam is based on the breadth of the beam. The selection of the breadth is based on the type of data that is desired to be generated. For example, a narrow laser beam is narrower in breadth than a broad laser beam.

The selection of the breadth for a laser beam in these examples is based on the type of sensor data that is desired. The breadth of a narrow laser beam is selected such that optical air data can be generated from backscatter light detected in response to the laser beam. The breadth of a broad laser beam is selected to generate object data that enables detecting objects within an area or field of view (FOV). A greater breadth increases the ability to detect the presence of an object.

In this illustrative example, flying car 101 emits narrow laser beams 111 that results in backscatter light from backscattering of narrow laser beams 111. This backscatter light is detected and used to generate optical air data. In this example, flying car 101 also emits broad laser beam 112 to generate object data.

Broad laser beam 112 results in backscatter light that is detected and used to generate object data. In this example, the backscatter light is generated in response to broad laser beam 112 scattering of flying car 103. This object data is used to detect the presence of flying car 103.

Flying car 102 emits narrow laser beams 115 and broad laser beam 116. Backscatter light detected in response to narrow laser beams 115 is used to generate optical air data. Object data generated in response to backscatter light detected from broad laser beam 116 is used to detect the presence of flying car 103. In this depicted example, flying car 103 emits broad laser beam 117. The backscatter light detected in response to broad laser beam 117 is used to generate object data. In this case, the object data indicates the presence of person 120.

FIG. 1 is intended as an example and not as an architectural limitation for the different illustrative embodiments. For example, other types of vehicles using lidar systems in the present. Aircraft, ground vehicles, and other types of vehicles can also be present in vehicle lidar network 100. Further, the illustrative example only depicts three flying cars. As the number of flying cars or other vehicles increases, the potential for interference increases.

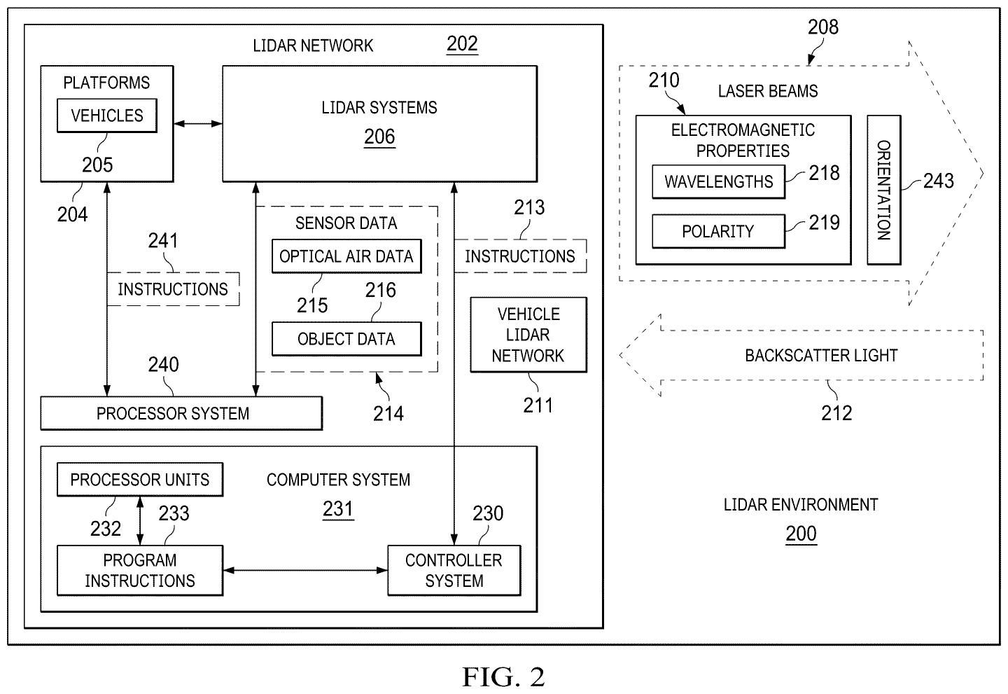

With reference now to FIG. 2, an illustration of a block diagram of a lidar environment is depicted in accordance with an illustrative embodiment. Lidar environment 200 is an environment in which lidar network 202 comprises platforms 204 and lidar systems 206. Lidar systems 206 are located in platforms 204. In this illustrative example, each of these platforms has a lidar system. In some illustrative examples, a platform can have more than one lidar system.

Platforms 204 can take a number of different forms. For example, platforms 204 can be selected from at least one of a mobile platform, a stationary platform, a land-based structure, an aquatic-based structure, a space-based structure, an aircraft, a commercial airplane, a rotorcraft, a tilt-rotor aircraft, a tilt wing aircraft, a vertical takeoff and landing aircraft, an electrical vertical takeoff and landing vehicle a personal air vehicle, an air-land vehicle, an autonomous vehicle, an autonomous ground vehicle, an autonomous air vehicle, an autonomous air and ground vehicle, an unmanned aerial vehicle, an unmanned quadcopter, a surface ship, a tank, a personnel carrier, a train, a spacecraft, a space station, a satellite, an automobile, a building, a traffic control tower, an airport, a rocket, or other types of platforms.

The phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

In one illustrative example, platforms 204 can be vehicles 205. With this example, lidar network 202 is vehicle lidar network 211. Vehicles 205 can be selected from at least one of an aircraft, a commercial airplane, a rotorcraft, a tilt-rotor aircraft, a tilt wing aircraft, a vertical takeoff and landing aircraft, an electrical vertical takeoff and landing vehicle, a personal air vehicle, an air-land vehicle, an autonomous vehicle, an autonomous air-land vehicle, a surface ship, a tank, a personnel carrier, a train, a spacecraft, or other suitable vehicles.

In this example, vehicles 205 operate within a region. This region can be, for example, a city, a state, a predefined airspace, or some other suitable region.

As depicted, lidar systems 206 are configured to emit laser beams 208. Backscatter light 212 is generated in response to scattering of laser beams 208. This backscatter light is detected by lidar systems 206 to generate sensor data 214 using backscatter light 212. Sensor data 214 can include at least one of optical air data 215 or object data 216.

In this illustrative example, optical air data 215 can include a number of parameters selected from at least one of an airspeed, an angle-of-sideslip, an angle-of-attack, a cloud density, an air density, a temperature, a pressure, a clear air turbulence, or other parameters. Object data 216 is data that can be used for object detection.

In these examples, a lidar system can be implemented using any currently available lidar system. A lidar (light detection and ranging) system includes a number of different components. For example, a lidar system can include a laser source, a receiver, and a controller.

The laser source can emit one or more laser beams. These laser beams can be scattered by air molecules, aerosols, or both. The laser beams can also be scattered or reflected. The scattering and reflection of laser beams can be detected by the receiver. The receiver can be implemented using one or more photodetectors. The photodetectors convert the backscatter into electrical signals. The electrical signals can be processed by a controller that generates the sensor data. In some illustrative examples, electrical signals are the sensor data.

As depicted, sensor data 214 is generated by lidar systems 206 in vehicles 205 from detecting backscatter light 212. Sensor data 214 can be sent to processor system 240 and processed by processor system 240 located in a portion of vehicles 205 or in a remote location. The portion of vehicles 205 is selected from some or all of vehicles 205.

In this example, processor system 240 can be implemented using a data processing system located in computer system 231 or in some other location. Vehicles 205 can execute instructions 241 received from processor system 240. Instructions 241 can include at least one of a change in speed, a change in direction, a new waypoint, a change in altitude, or instructions for the operation of vehicle 205. These instructions can include at least one of the suggested changes, commands, data, or other information that can be used operate vehicle 205. In these illustrative examples, instructions 241 may be implemented by an operator of a vehicle when the vehicle is a manned vehicle. In another example, instructions 241 can be implemented by a controller or computer operating the vehicle when the vehicle is an autonomous vehicle but does not require a human operator to operate the vehicle.

In this illustrative example, lidar systems 206 are configured to emit laser beams 208 having a number of electromagnetic properties 210. In this example, the number of electromagnetic properties 210 is selected to reduce interference caused by other laser beams emitted from other lidar systems. In one illustrative example, the other lidar systems can be lidar systems in lidar systems 206 in vehicle lidar network 211. In another illustrative example, the other lidar systems can be in other networks or for other vehicles or platforms not part of vehicle lidar network 211.

In this illustrative example, lidar systems 206 emit one or more of laser beams 208 with a number of electromagnetic properties 210 that reduce interference when detecting backscatter. This interference can be reduced even in the presence of other laser beams emitted by other lidar systems.

The number of electromagnetic properties can be selected from at least one of a number of wavelengths 218 or polarity 219. In this example, polarity 219 is the polarity of the light in a laser beam.

In one illustrative example, the number of electromagnetic properties 210 can be reconfigured in lidar systems 206. In another illustrative example, the number of electromagnetic properties 210 can be dynamically changed during operation of lidar systems 206. In other words, one or more electromagnetic properties 210 can be changed in one or more lidar systems 206 for vehicle 205 during the operation of vehicle 205. For example, these changes can be made while vehicle 205 are moving or otherwise operating. As a result, some or all of lidar systems 206 may have a change in one or more of the number of electromagnetic properties 210 in which the changes made to reduce interference in the operation of lidar systems 206 in vehicle lidar network 211.

In one illustrative example, lidar network 202 includes controller system 230. In this illustrative example, controller system 230 can be distributed in one or more data processing systems, for example, wherein controller system 230 is selected from one of a distributed controller system located in the vehicles and a centralized controller system in a location. Controller system 230 can be located in some or all of vehicles 205. When centralized in a location, the location can be in a vehicle, a control center, a traffic control tower, or other location.

In this illustrative example, controller system 230 includes a number of components that can be implemented in hardware. Controller system 230 can be implemented in software, hardware, firmware or a combination thereof. When software is used, the operations performed by controller system 230 can be implemented in program instructions 233 configured to run on hardware, such as a number of processor units 232. When firmware is used, the operations performed by controller system 230 can be implemented in program instructions 233 and data and stored in persistent memory to run on a processor unit. When hardware is employed, the hardware can include circuits that operate to perform the operations in controller system 230.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 231 is a physical hardware system and includes one or more data processing systems. When more than one data processing system is present in computer system 231, those data processing systems are in communication with each other using a communications medium. The data processing systems can be present within one or more of platforms 204. The communications medium can be a network. The data processing systems can be selected from at least one of a computer, a vehicle computer, controller, a platform computer, a server computer, a tablet computer, or some other suitable data processing system.

As depicted, computer system 231 includes a number of processor units 232 that are capable of executing program instructions 233 implementing processes in the illustrative examples. In other words, program instructions 233 are computer-readable program instructions.

As used herein, a processor unit in the number of processor units 232 is a hardware device and is comprised of hardware circuits such as those on an integrated circuit that respond to and process instructions and program code that operate a computer. When the number of processor units 232 executes program instructions 233 for a process, the number of processor units 232 can be one or more processor units that are in the same computer or in different computers. In other words, the process can be distributed between processor units 232 on the same or different computers in computer system 231.

Further, the number of processor units 232 can be of the same type or different types of processor units. For example, the number of processor units 232 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, controller system 230 is configured to select the number of electromagnetic properties 210 to reduce the interference from the other lidar systems. Further in this example, in selecting the number of electromagnetic properties 210, controller system 230 changes a number of wavelengths 218 used by a number of lidar systems 206 to reduce the interference from the other lidar systems.

Controller system 230 can dynamically change a number of wavelengths 218 used by a number of lidar systems 206 to reduce the interference from the other lidar systems. In other words, controller system 230 can change the number of wavelengths 218 used by a number of lidar systems 206 during operation of those lidar systems in platforms 204 such as vehicles 205 in a mix of different types of platforms 204. This type of change is in contrast to pre-selecting wavelengths 218 prior to the operation of vehicles 205.

In this example, a number of wavelengths 218 may be changed only for some of lidar systems 206 to reduce the amount of interference. In these illustrative examples, the number of wavelengths 218 do not need to be changed such that every lidar system in lidar systems 206 uses a different wavelength in wavelengths 218. The selection can be made to reduce interference. Further, the selection can also be made depending on the location or direction of travel for different vehicles 205.

In another illustrative example, in selecting the number of electromagnetic properties 210, controller system 230 changes polarity 219 of laser beams 208 used by a number of lidar systems 206 to reduce the interference from the other lidar systems. In this example, controller system 230 can dynamically change polarity 219 used by a number of lidar systems 206 to reduce the interference from the other lidar systems during operation of vehicles 205. In other words, changing polarity 219 without changing wavelengths 218 may reduce interference between lidar systems 206.

In changing polarity 219 of laser beams 208 used by a number of lidar systems 206, polarity 219 can be changed for one or more of the laser beams 208. For example, polarity 219 can be changed for one of laser beams 208 emitted by a lidar system in lidar systems 206. In another illustrative example, polarity 219 can be changed for 6, 10, or some other number of lidar systems 206 emitted laser beams 208.

In this illustrative example, the dynamic change to the number of electromagnetic properties 210 for laser beams 208 emitted by lidar systems 206 can be initiated a number of different ways. For example, the location of vehicles 205 within a region can be used to determine whether changes to the number of electromagnetic properties 210 is needed. For example, if the number of vehicles 205 having the same number of electromagnetic properties 210 are present within a region, controller system 230 can control lidar systems 206 to change electromagnetic properties 210 such that interference is reduced. The region can be an area around an airport. In another example, the region can be a city, a state, a select airspace, or other suitable area.

In another illustrative example, controller system 230 can perform a dynamic change to the number of electromagnetic properties 210 in response to detecting sensor data 214 that is erroneous sensor data. For example, if optical air data 215 in sensor data 214 indicates that a vehicle is traveling at a speed of Mach 2 on the ground, this speed can be considered erroneous. One or more electromagnetic properties 210 can be changed for the lidar system in that vehicle or lidar systems in other vehicles in the region to reduce interference causing erroneous readings from sensor data 214.

In this example, the change in the number of electromagnetic properties 210 can be performed by controller system 230 sending instructions 213 to lidar systems 206. These instructions can include at least one of changes for selected electromagnetic properties 210 or commands for data that can be used to change a number of electromagnetic properties 210 for one or more of lidar systems 206.

In yet another illustrative example, controller system 230 can select the number of electromagnetic properties 210 by changing a number of wavelengths 218 used by a first number of lidar systems 206 to reduce the interference from the other lidar systems and changing polarity 219 of laser beams 208 used by a second number of the lidar systems 206 to reduce the interference from the other lidar systems. In these illustrative examples, the first number of lidar systems 206 and the second number of lidar systems 206 can be the same or different lidar systems in lidar systems 206.

In another illustrative example, controller system 230 is configured to change orientation 243 of a laser beam in laser beams 208 emitted by a lidar system in lidar systems 206, wherein interference caused by other laser beams emitted from other lidar systems in detecting backscatter light is reduced. In this example, the changed orientation reduces the interference caused by the laser beams emitted from the other lidar systems. For example, the laser beam can be adjusted to have an angle of 2 degrees, 4 degrees, or some other change from the initial orientation of the laser beam. This change in orientation 243 can be performed using a positioning system, optical elements, or other components in the lidar system.

In yet another illustrative example, one or more lidar systems 206 can be configured to determine when backscatter light 212 is greater than a threshold and filter backscatter light 212 to reduce the interference. In this example, backscatter light 212 can be greater than a threshold by measuring a parameter for the backscatter light and comparing that measured parameter to the threshold.

For example, maximum backscatter signal power (or reflected signal power) for backscatter light 212 can be determined as a function of the environment. This determination can be performed empirically, theoretically, or empirically and theoretically to determine the maximum backscatter signal power for backscatter light.

Further, a safety factor can be added to the threshold value. For example, for an aircraft flying on a clear day, the maximum backscatter signal power value may be X dBm. If a power higher than 10X dBm is detected by a lidar system, that maximum backscatter signal power value is blocked, discarded, or otherwise not used. In another example, for the aircraft flying through clouds, the maximum backscatter signal power value may be Y dBm. As a result, if the maximum backscatter signal power detected is greater than 10Y dBm, that maximum backscatter signal power value is blocked, discarded, or otherwise not used.

In yet another example, for a ground vehicle, the maximum reflected power for backscatter light generated in response to a laser beam being scattered by another car can be Z dBm. With this example, if maximum reflected power detected is greater than 10Z dBm, that maximum reflected power is blocked, discarded, or otherwise not need.

Thus, illustrative examples enable many platforms to operate lidar systems simultaneously without interfering with each other. This type of lidar system management can be used with platforms such as vehicles, and in particular with aircraft. Further, this type of management can also be used with different types of platforms such as buildings, aircraft, ground vehicles, and other suitable platforms.

In the different illustrative examples, platforms can be assigned or instructed to use a unique number of electromagnetic properties that reduces the occurrence of erroneous sensor data generated by lidar systems. In the illustrative examples, a lidar system transmits one or more laser beams and receives backscatter data using the number of electromagnetic properties assigned to that lidar system. As depicted, these electromagnetic properties can include wavelength, polarity, or both.

The illustration of lidar environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

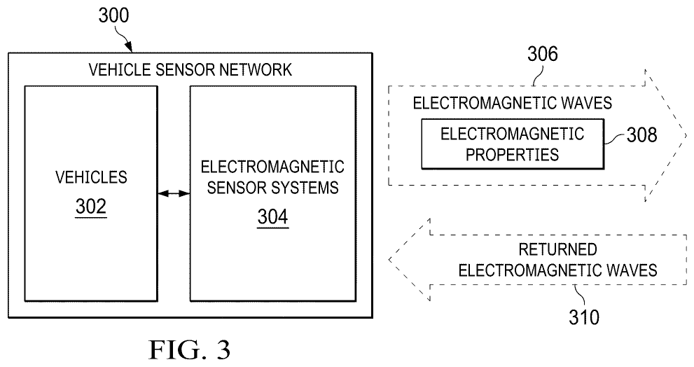

For example, in FIG. 3, an illustration of a block diagram of a vehicle sensor network is depicted in accordance with an illustrative embodiment. In this example, vehicle sensor network 300 is an example of another type of sensor network that can be used in addition to or in place of vehicle lidar network 211 in FIG. 2.

As depicted in this example, vehicle sensor network 300 comprises vehicles 302 and electromagnetic sensor systems 304. In this example, electromagnetic sensor systems 304 are located in vehicles 302. Each vehicle in vehicles 302 may have one or more of electromagnetic sensor systems 304.

In this illustrative example, electromagnetic sensor systems 304 are configured to emit electromagnetic waves 306 having a number of electromagnetic properties 308. Further in this example, electromagnetic waves 306 can take a number of different forms. For example, electromagnetic waves 306 can be selected from at least one of a laser beam, a radio wave, a microwave beam, an ultraviolet beam, or other types of electromagnetic waves 306. In this example, a radio wave can be 10⁻⁶ Hz to 10⁻² Hz. The number of electromagnetic properties 308 is selected to reduce interference caused by electromagnetic waves emitted from other electromagnetic sensor systems in detecting returned electromagnetic waves 310.

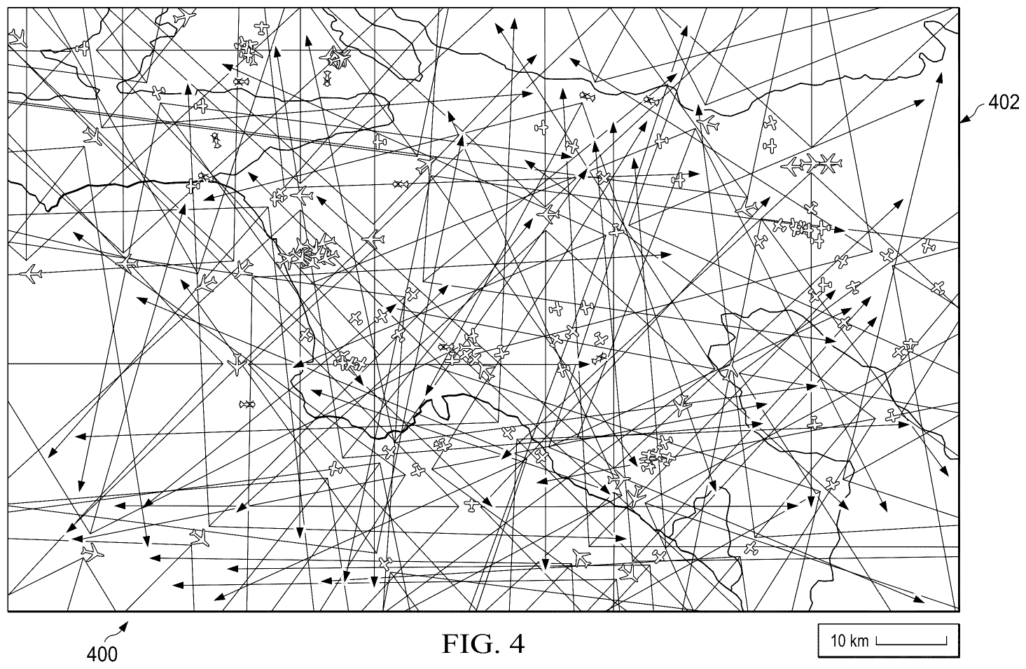

With reference next to FIG. 4, an illustration of aircraft with lidar systems is depicted in points with an illustrative embodiment. In this illustrative example, aircraft 400 are in region 402. As depicted, each of aircraft 400 has a lidar system. As can be seen in this illustrative example, lidar systems emit laser beams during operation of aircraft 400. The emission of these laser beams can result in interference when a laser beam having a wavelength is detected by a lidar system using the same wavelength.

In this illustrative example, the interference in region 402 between aircraft 400 is reduced by selecting electromagnetic properties laser beams emitted by the lidar systems used by aircraft 400. In these illustrative examples, these electromagnetic properties can include at least one of a wavelength or a polarity.

In one illustrative example, these electromagnetic properties can be pre-configured in the lidar systems used by aircraft 400. Further, in another illustrative example, these electromagnetic properties can be changed or adjusted dynamically during operation of aircraft 400. As described in other examples, the change to the electromagnetic properties can be selected to decrease the probability of interference between lidar systems used by aircraft 400.

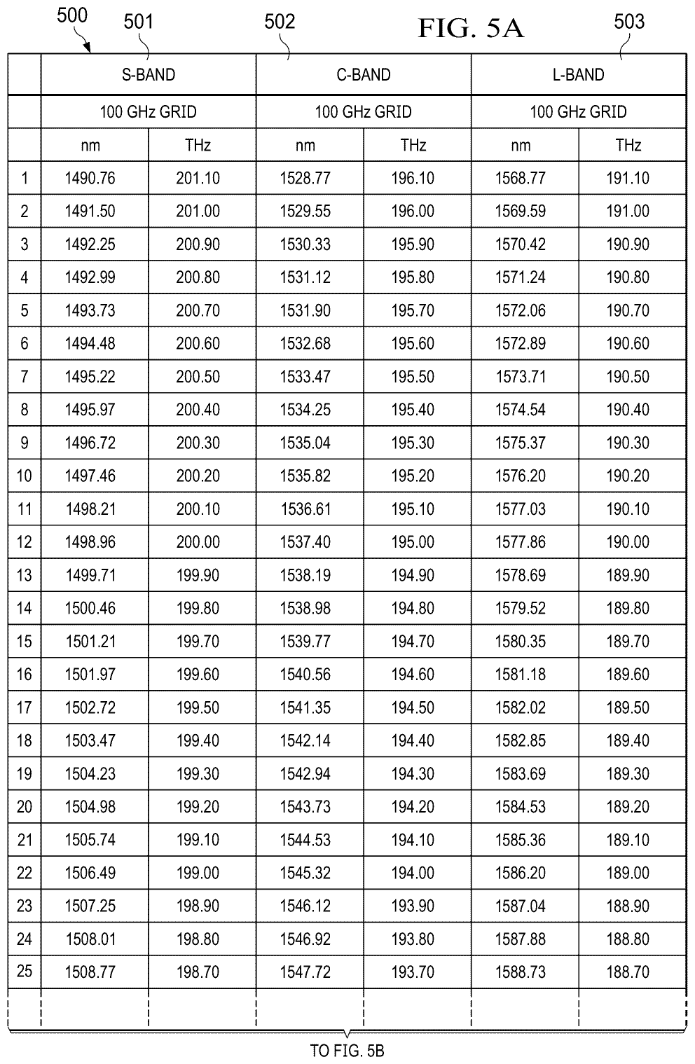

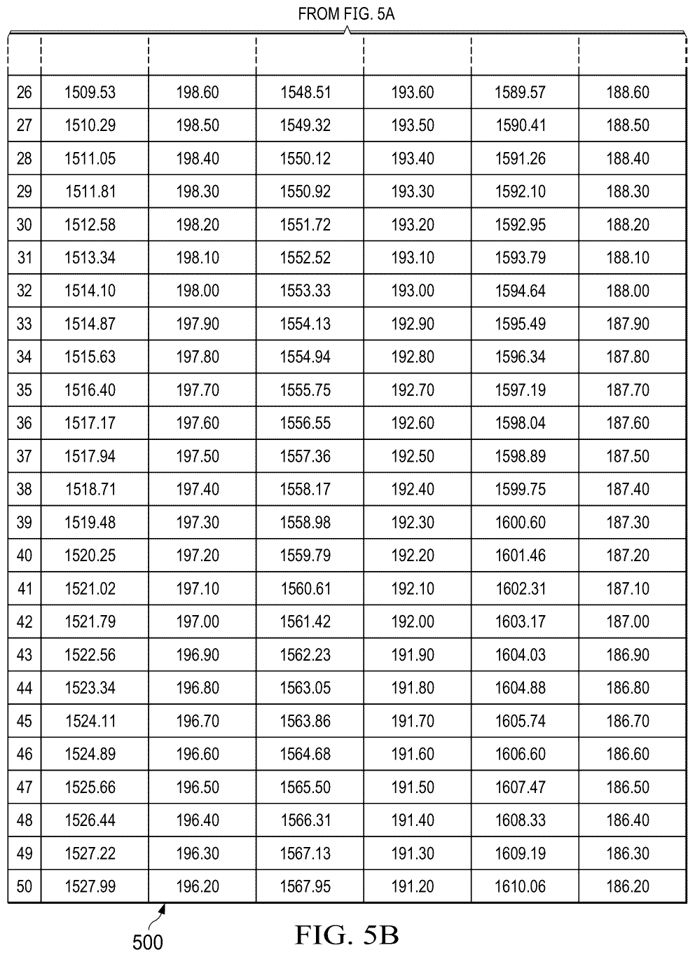

Turning next to FIGS. 5A and 5B, illustrations of channels for laser beam wavelength is depicted in accordance with an illustrative item. In this illustrative example, table 500 illustrates a portion of a dense wavelength division multiplexing (DWDM) ITU (International Telecommunication Union) grid specification. This table depicts a standardized system that divides the spectrum of light for use in fiber optic communications. In this example, table 500 has channels for S-Band 501, C-Band 502, and L-Band 503.

In this example, channels identifying wavelengths and corresponding frequencies for light can be used to select wavelengths for lidar systems in lidar network 202 such as vehicle lidar network 211 in FIG. 2. In these illustrative examples, different channels can be configured in lidar systems that are manufactured for use in aircraft or other vehicles. For example, a bandpass filter for passing light that is used to generate sensor data can be selected for a particular channel.

Further, in some illustrative examples these channels can be selected during operation of the vehicles. In other words, the channels can be dynamically changed during operation of vehicles. With this example, the bandpass filter can be changed or adjusted to use different channels. Additionally, the laser source can also be adjusted to emit a laser beam for the desired channel.

These changes to lidar systems can be based on channels being used by different vehicles in a region. In other examples, the changes made based on channels used by aircraft in an aircraft fleet used by a particular airline. Further, the number of channels illustrated in this example can be increased by the selection of polarity for each channel. For example, a particular wavelength in the channel can be assigned twice with one assignment for polarity vertical to the ground and another assignment for a polarity horizontal to the ground.

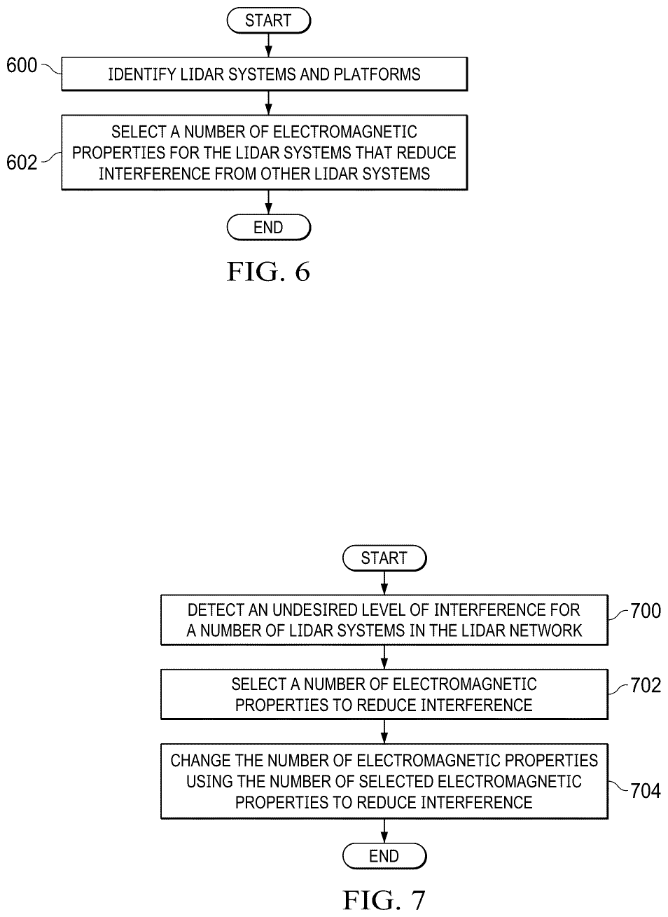

Turning next to FIG. 6, an illustration of a flowchart of a process for operating a lidar network is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in lidar network 202 in FIG. 2.

The process identifies lidar systems and platforms (operation 600). The process then selects a number of electromagnetic properties for the lidar systems that reduce interference from other lidar systems (operation 602). The process terminates thereafter. In operation 602, this process can be implemented by selecting lidar systems for use in platforms. In other illustrative examples, the process can dynamically change electromagnetic properties for the lidar systems during operation of the lidar systems.

With reference now to FIG. 7, an illustration of a flowchart of a process for operating a lidar network is depicted in accordance with an illustrative embodiment. The process in FIG. 7 can be implemented in hardware, software, or both. When implemented in software, the process can take the form of program instructions that are run by one or more processor units located in one or more hardware devices in one or more computer systems. For example, the process can be implemented in lidar network 202 in FIG. 2. In this example, this process can be implemented in controller system 230 in lidar network 202 in FIG. 2. This process can be initiated each time undesired interference is determined for one or more lidar systems.

The process begins by detecting an undesired level of interference for a number of lidar systems in the lidar network (operation 700). In operation 700, this interference can be caused by lidar systems in the lidar network or other lidar systems outside of the lidar network.

The process selects a number of electromagnetic properties to reduce interference (operation 702). In this illustrative example, the controller system can identify changes selected from at least one of a wavelength or a polarity for one or more lidar systems in the lidar network.

The analysis can be based on the location of platforms having the lidar systems. Further, the analysis can also be based on actual interference detected for the lidar systems in the platforms.

These changes can be for the number of lidar systems determined to have an undesired level of interference. In other examples, these changes can be to other lidar systems other than, or in addition to, those lidar systems having an undesired level of interference.

The process changes the number of electromagnetic properties using the number of selected electromagnetic properties to reduce interference (operation 704). The process terminates thereafter. In operation 704, instructions can be sent to a number of the lidar systems selected to have changes to the number of electromagnetic properties.

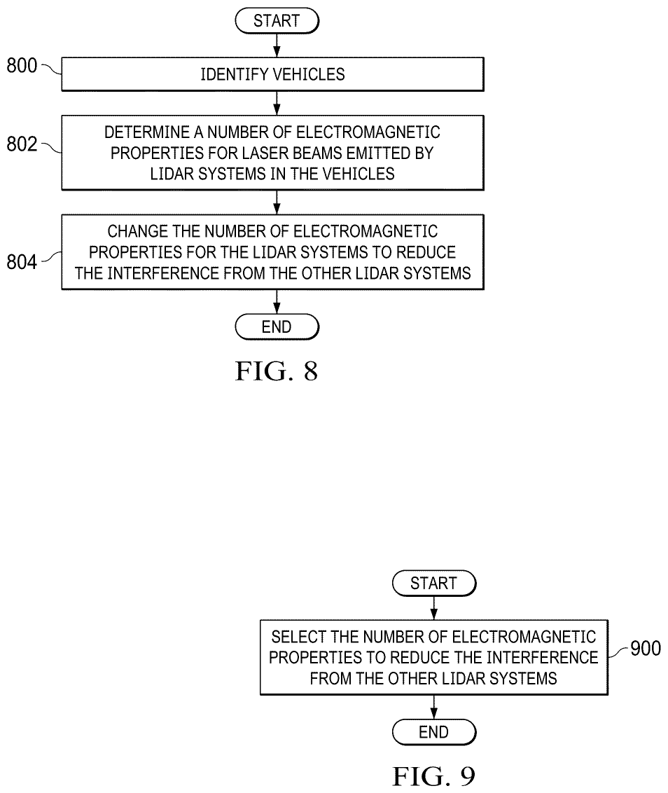

Turning now to FIG. 8, an illustration of a flowchart of a process for operating a vehicle lidar network is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in controller system 230 in FIG. 2.

The process begins by identifying vehicles (operation 800). In operation 800, the vehicles can be identified in a number of different ways. For example, the vehicles can be vehicles in a fleet of vehicles. In another example, the vehicles can be those within a particular region. This region can be an area around an airport, a city, county, a state, an airspace, or other type of region. In these examples, a region can be one or more layered zones having boundaries.

The process determines a number of electromagnetic properties for laser beams emitted by lidar systems in the vehicles (operation 802). The process changes the number of electromagnetic properties for the lidar systems to reduce the interference from the other lidar systems (operation 804). The process terminates thereafter.

Turning next to FIG. 9, an illustration of a flowchart of a process for selecting electromagnetic properties is depicted in accordance with an illustrative embodiment. This process is an example of an operation that can be performed with the operations in FIG. 8.

The process selects the number of electromagnetic properties to reduce the interference from the other lidar systems (operation 900). The process terminates thereafter.

The flowchart in this example shows selecting the number of electromagnetic properties as being a separate step from changing the number of electromagnetic properties in operation 804. In other illustrative examples, this selecting operation can include performing the change of the electromagnetic properties identified.

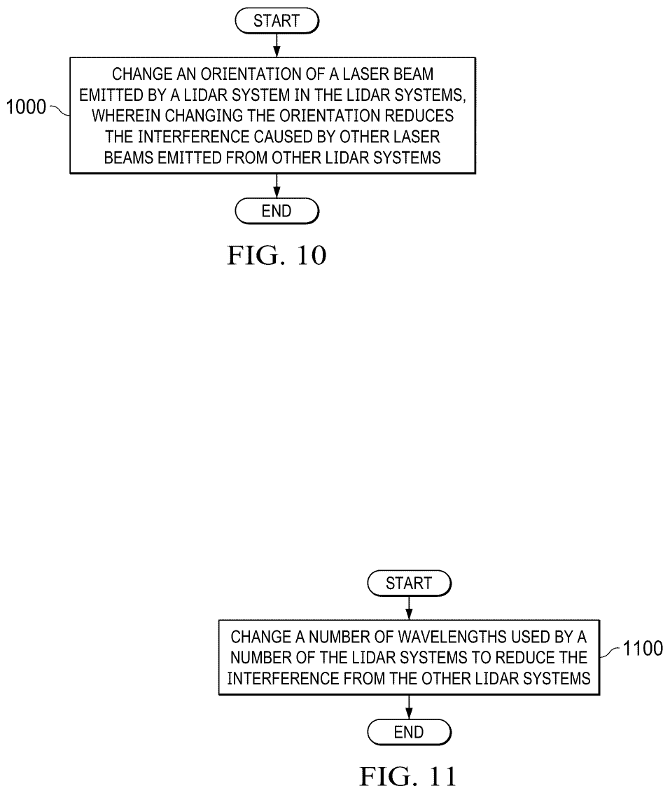

Next in FIG. 10, an illustration of a flowchart of process for changing a laser beam orientation is depicted in accordance with an illustrative embodiment. The process in this figure is an example of an operation that can be performed with the operations in FIG. 8.

The process changes an orientation of a laser beam emitted by a lidar system in the lidar systems, wherein changing the orientation reduces the interference caused by other laser beams emitted from other lidar systems (operation 1000). The process terminates thereafter.

Turning now to FIG. 11, an illustration of a flowchart of a process for changing a number of electromagnetic properties is depicted in accordance with an illustrative embodiment. This process is an example of an implementation for operation 804 in FIG. 8.

The process changes a number of wavelengths used by a number of the lidar systems to reduce the interference from the other lidar systems (operation 1100). The process terminates thereafter.

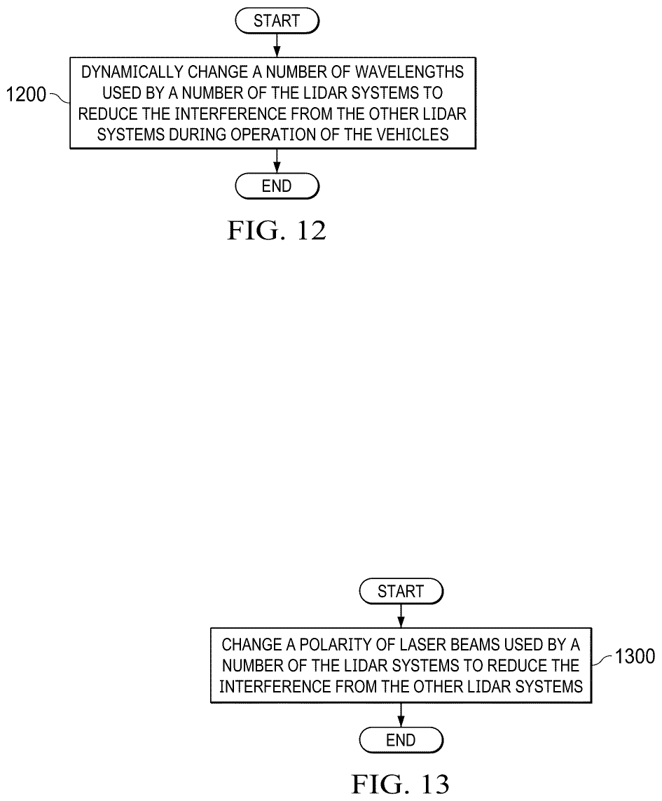

Turning now to FIG. 12, an illustration of a flowchart of a process for changing a number of electromagnetic properties is depicted in accordance with an illustrative embodiment. This process is an example of an implementation for operation 804 in FIG. 8.

The process dynamically changes a number of wavelengths used by a number of the lidar systems to reduce the interference from the other lidar systems during operation of the vehicles (operation 1200). The process terminates thereafter.

With reference to FIG. 13, an illustration of a flowchart of a process for changing a number of electromagnetic properties is depicted in accordance with an illustrative embodiment. This process is another example of an implementation for operation 804 in FIG. 8.

The process changes a polarity of laser beams used by a number of the lidar systems to reduce the interference from the other lidar systems (operation 1300). The process terminates thereafter.

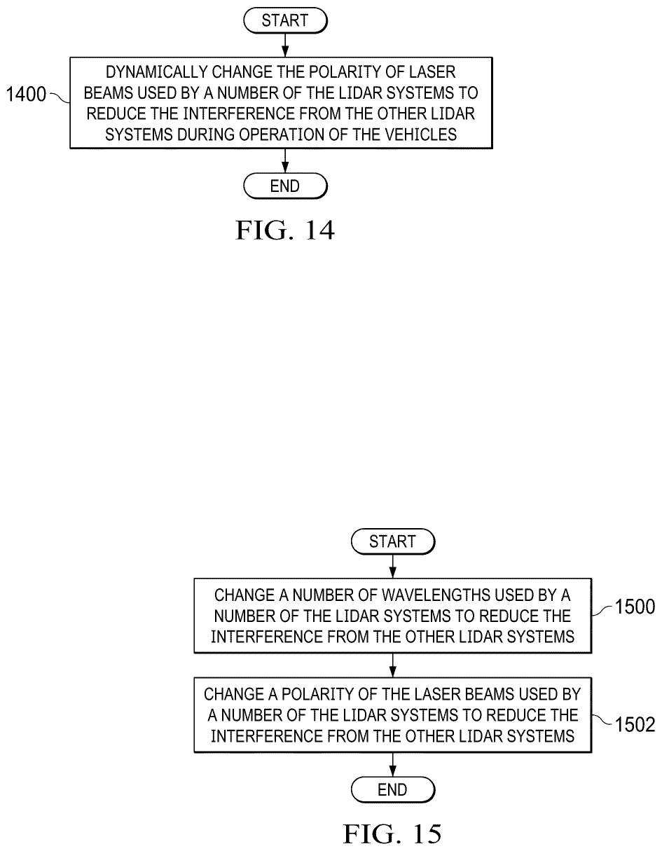

Next in FIG. 14, an illustration of a flowchart of a process for changing a number of electromagnetic properties is depicted in accordance with an illustrative embodiment. This process is yet another example of an implementation for operation 804 in FIG. 8.

The process dynamically changes the polarity of laser beams used by a number of the lidar systems to reduce the interference from the other lidar systems during operation of the vehicles (operation 1400). The process terminates thereafter.

Turning now to FIG. 15, an illustration of a flowchart of a process for changing a number of electromagnetic properties is depicted in accordance with an illustrative embodiment. This process is yet another example of an implementation for operation 804 in FIG. 8.

The process changes a number of wavelengths used by a number of the lidar systems to reduce the interference from the other lidar systems (operation 1500). The process changes a polarity of the laser beams used by a number of the lidar systems to reduce the interference from the other lidar systems (operation 1502). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

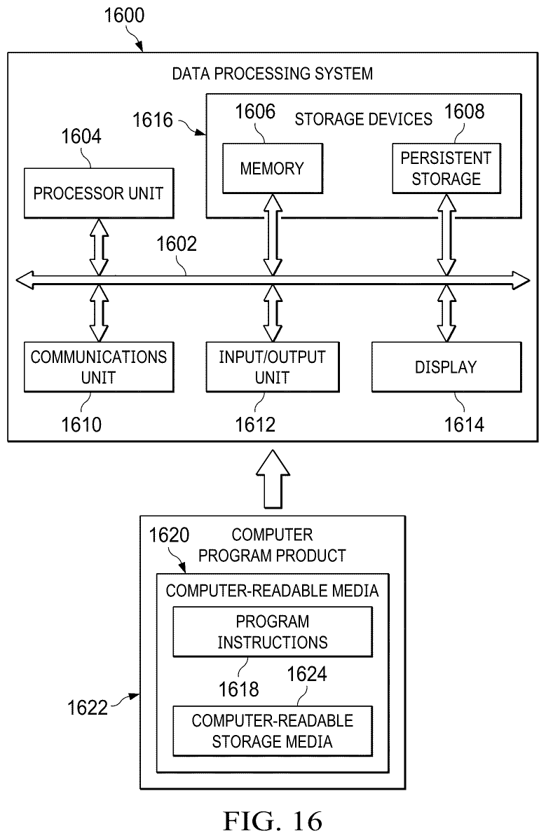

Turning now to FIG. 16, an illustration of a block diagram of a data processing system is depicted in accordance with an illustrative embodiment. Data processing system 1600 can be used to implement computer system 231 in FIG. 2. These data processing systems can also be used to computing components in flying car 101, flying car 102, flying car 103 in FIG. 1. Further, data processing system 1600 can be used to implement computing for data processing components or devices in platforms 204 in FIG. 2.

In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1604 can be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are referred to as program instructions, computer-usable program instructions, or computer-readable program instructions that can be read and executed by a processor in processor unit 1604. The program instructions in the different embodiments can be embodied on different physical or computer-readable storage media, such as memory 1606 or persistent storage 1608.

Program instructions 1618 are located in a functional form on computer-readable media 1620 that is selectively removable and can be loaded onto or transferred to data processing system 1600 for execution by processor unit 1604. Program instructions 1618 and computer-readable media 1620 form computer program product 1622 in these illustrative examples. In the illustrative example, computer-readable media 1620 is computer-readable storage media 1624.

Computer-readable storage media 1624 is a physical or tangible storage device used to store program instructions 1618 rather than a medium that propagates or transmits program instructions 1618. Computer-readable storage media 1624 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1624, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation, or garbage collection. However, these operations do not render the storage device as transitory because the data is not transitory while the data is stored in the storage device.

Alternatively, program instructions 1618 can be transferred to data processing system 1600 using a computer-readable signal media. The computer-readable signal media are signals and can be, for example, a propagated data signal containing program instructions 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program instructions 1618 can be located in computer-readable media 1620 in the form of a single storage device or system. In another example, program instructions 1618 can be located in computer-readable media 1620 that is distributed in multiple data processing systems. In other words, some instructions in program instructions 1618 can be located in one data processing system while other instructions in program instructions 1618 can be located in one data processing system. For example, a portion of program instructions 1618 can be located in computer-readable media 1620 in a server computer while another portion of program instructions 1618 can be located in computer-readable media 1620 located in a set of client computers.

The different components illustrated for data processing system 1600 are not meant to provide architectural limitations to the manner in which different embodiments can be implemented. In some illustrative examples, one or more of the components may be incorporated in or otherwise form a portion of, another component. For example, memory 1606, or portions thereof, may be incorporated in processor unit 1604 in some illustrative examples. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program instructions 1618.

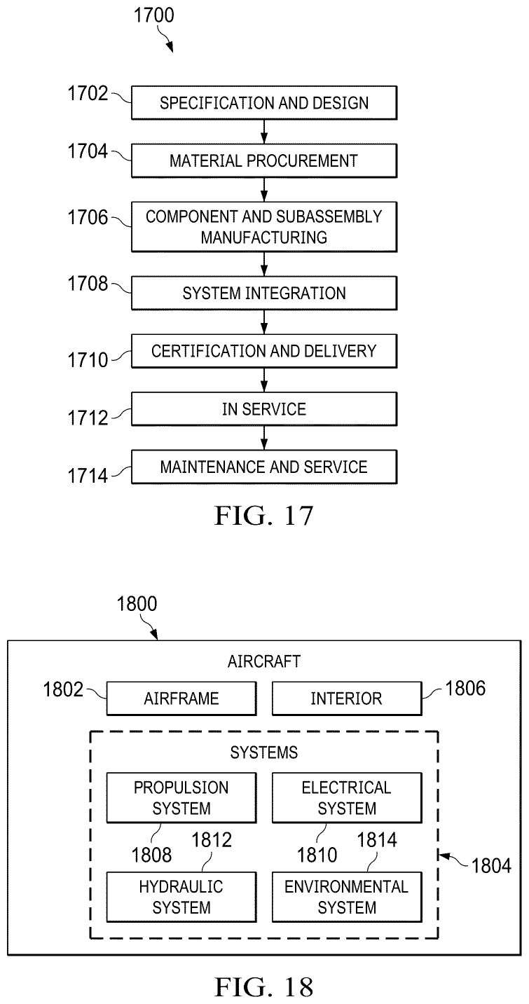

Illustrative embodiments of the disclosure may be described in the context of aircraft manufacturing and service method 1700 as shown in FIG. 17 and aircraft 1800 as shown in FIG. 18. Turning first to FIG. 17, an illustration of a block diagram of an aircraft manufacturing and service method is depicted in accordance with an illustrative embodiment. During pre-production, aircraft manufacturing and service method 1700 may include specification and design 1702 of aircraft 1800 in FIG. 18 and material procurement 1704.

During production, component and subassembly manufacturing 1706 and system integration 1708 of aircraft 1800 in FIG. 18 takes place. Thereafter, aircraft 1800 in FIG. 18 can go through certification and delivery 1710 in order to be placed in service 1712. While in service 1712 by a customer, aircraft 1800 in FIG. 18 is scheduled for routine maintenance and service 1714, which may include modification, reconfiguration, refurbishment, and other maintenance or service.

Each of the processes of aircraft manufacturing and service method 1700 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 18, an illustration of a block diagram of an aircraft is depicted in which an illustrative embodiment may be implemented. In this example, aircraft 1800 is produced by aircraft manufacturing and service method 1700 in FIG. 17 and may include airframe 1802 with plurality of systems 1804 and interior 1806. Examples of systems 1804 include one or more of propulsion system 1808, electrical system 1810, hydraulic system 1812, and environmental system 1814. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1700 in FIG. 17.

In one illustrative example, components or subassemblies produced in component and subassembly manufacturing 1706 in FIG. 17 can be fabricated or manufactured in a manner similar to components or subassemblies produced while aircraft 1800 is in service 1712 in FIG. 17. As yet another example, one or more apparatus embodiments, method embodiments, or a combination thereof can be utilized during production stages, such as component and subassembly manufacturing 1706 and system integration 1708 in FIG. 17. One or more apparatus embodiments, method embodiments, or a combination thereof may be utilized while aircraft 1800 is in service 1712, during maintenance and service 1714 in FIG. 17, or both. The use of a number of the different illustrative embodiments may substantially expedite the assembly of aircraft 1800, reduce the cost of aircraft 1800, or both expedite the assembly of aircraft 1800 and reduce the cost of aircraft 1800.

For example, lidar systems can be designed, manufactured and implemented during at least one of specification and design 1702, component and subassembly manufacturing 1706, or system integration 1708 for aircraft 1800. Further, lidar systems in the different illustrative examples can be implemented during maintenance and service 1714. This maintenance and service can include modification, reconfiguration, refurbishment, and other maintenance or service. Further, lidar systems can be operated and managed to reduce interference during the operation of aircraft 1800 during in service 1712.

Thus, the illustrative embodiments provide a method, apparatus, system, and computer program product for reducing interference between lidar systems used in platforms. In one example, s vehicle lidar network comprises a vehicle and lidar systems in the vehicle. The lidar systems are configured to emit laser beams having a number of electromagnetic properties in which the number of electromagnetic properties is selected to reduce interference caused by other laser beams emitted from other lidar systems in detecting backscatter light.

Consequently, many platforms can operate lidar systems simultaneously without interfering with each other. This type of lidar system management can be used with platforms such as vehicles and in particular with aircraft.

In the different illustrative examples, platforms can be assigned a unique number of electromagnetic properties that reduces the occurrence of erroneous sensor data generated by lidar systems. In the illustrative examples, a lidar system transmits one or more laser beams and receives backscatter data using the number of electromagnetic properties assigned to that lidar system. As depicted, these electromagnetic properties can include wavelength, polarity, or both.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes,” “including,” “has,” “contains,” and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A vehicle lidar network comprising:
vehicles; and
lidar systems in the vehicles, wherein the lidar systems are configured to emit laser beams having a number of electromagnetic properties in which the number of electromagnetic properties is selected to reduce interference caused by laser beams emitted from other lidar systems.

2. The vehicle lidar network of claim 1, further comprising:
a controller system configured to select the number of electromagnetic properties to reduce the interference from the other lidar systems.

3. The vehicle lidar network of claim 1, further comprising:
a controller system configured to change an orientation of a laser beam emitted by a lidar system in the lidar systems, wherein the changed orientation reduces the interference caused by other laser beams emitted from the other lidar systems.

4. The vehicle lidar network of claim 2, wherein in selecting the number of electromagnetic properties, the controller system is configured to:
change a number of wavelengths used by a number of the lidar systems to reduce the interference from the other lidar systems.

5. The vehicle lidar network of claim 2, wherein in selecting the number of electromagnetic properties, the controller system is configured to:
dynamically change a number of wavelengths used by a number of the lidar systems to reduce the interference from the other lidar systems during operation of the vehicles.

6. The vehicle lidar network of claim 2, wherein in selecting the number of electromagnetic properties, the controller system is configured to:
change a polarity of the laser beams used by a number of the lidar systems to reduce the interference from the other lidar systems.

7. The vehicle lidar network of claim 2, wherein in selecting the number of electromagnetic properties, the controller system is configured to:
dynamically change a polarity used by a number of the lidar systems to reduce the interference from the other lidar systems during operation of the vehicles.

8. The vehicle lidar network of claim 2, wherein in selecting the number of electromagnetic properties, the controller system is configured to:
change a number of wavelengths used by a first number of the lidar systems to reduce the interference from the other lidar systems; and
change a polarity of the laser beams used by a second number of the lidar systems to reduce the interference from the other lidar systems.

9. The vehicle lidar network of claim 2, wherein the controller system is selected from one of a distributed controller system located in the vehicles or a centralized controller system in a location.

10. The vehicle lidar network of claim 1, wherein the vehicles operate within a region.

11. The vehicle lidar network of claim 1, wherein:
the lidar systems in the vehicles generate sensor data using backscatter light;
the sensor data is processed by a processor system located in a portion of the vehicles or in a remote location; and
the vehicles execute instructions received from the processor system.

12. The vehicle lidar network of claim 1, wherein the number of electromagnetic properties is selected from at least one of a wavelength or a polarity.

13. The vehicle lidar network of claim 11, wherein the portion of the vehicles is selected from some or all of the vehicles.

14. The vehicle lidar network of claim 1, wherein the lidar systems are configured to:
determine when a backscatter light is greater than a threshold; and
filter backscatter light.

15. The vehicle lidar network of claim 1, wherein the vehicles are selected from at least one of an aircraft, a commercial airplane, a rotorcraft, a tilt-rotor aircraft, a tilt wing aircraft, a vertical takeoff and landing aircraft, an electrical vertical takeoff and landing vehicle a personal air vehicle, an air-land vehicle, an autonomous vehicle, an autonomous air-land vehicle, a surface ship, a tank, a personnel carrier, a train, a spacecraft, or a rocket.

16. A lidar network comprising:
platforms; and
lidar systems in the platforms, wherein the lidar systems are configured to emit laser beams having a number of electromagnetic properties in which the number of electromagnetic properties is selected to reduce interference caused by other laser beams emitted from other lidar systems.

17. The lidar network of claim 16, further comprising:
a controller system configured to select the number of electromagnetic properties for the lidar systems in the platforms to reduce the interference from the other lidar systems.

18. The lidar network of claim 17, wherein in selecting the number of electromagnetic properties, the controller system is configured to:
dynamically select the number of electromagnetic properties for the lidar systems in the platforms to reduce the interference from the other lidar systems during operation of the platforms.

19. The lidar network of claim 17, wherein in selecting the number of electromagnetic properties, the controller system is configured to:
change a number of wavelengths used by a number of the lidar systems to reduce the interference from the other lidar systems.

20. The lidar network of claim 17, wherein in selecting the number of electromagnetic properties, the controller system is configured to:
dynamically change a number of wavelengths used by a number of the lidar systems to reduce the interference from the other lidar systems during operation of the platforms.

21. The lidar network of claim 17, wherein in selecting the number of electromagnetic properties, the controller system is configured to:
change a polarity of the laser beams used by a number of the lidar systems to reduce the interference from the other lidar systems.

22. The lidar network of claim 17, wherein in selecting the number of electromagnetic properties, the controller system is configured to:
dynamically change a polarity used by a number of the lidar systems to reduce the interference from the other lidar systems during operation of the platforms.

23. The lidar network of claim 16, wherein the platforms are selected from at least one of a mobile platform, a stationary platform, a land-based structure, an aquatic-based structure, a space-based structure, an aircraft, a commercial airplane, a rotorcraft, a tilt-rotor aircraft, a tilt wing aircraft, a vertical takeoff and landing aircraft, an electrical vertical takeoff and landing vehicle a personal air vehicle, an air-land vehicle, an autonomous vehicle, an autonomous ground vehicle, an autonomous air vehicle, an autonomous air and ground vehicle, an unmanned aerial vehicle, an unmanned quadcopter, a surface ship, a tank, a personnel carrier, a train, a spacecraft, a space station, a satellite, an automobile, a building, a traffic control tower, an airport, or a rocket.

24. A vehicle sensor network comprising:
vehicles; and
electromagnetic sensor systems in the vehicles, wherein the electromagnetic sensor systems are configured to emit electromagnetic waves having a number of electromagnetic properties in which the number of electromagnetic properties is selected to reduce interference caused by other electromagnetic waves emitted from other electromagnetic sensor systems.

25. The vehicle sensor network of claim 24, wherein the electromagnetic waves are selected from at least one of a laser beam, a radio wave, a microwave beam, or an ultraviolet beam.

26. A method of operating a vehicle lidar network, the method comprising:
identifying vehicles;
determining a number of electromagnetic properties of laser beams emitted by lidar systems in the vehicles; and
changing the number of electromagnetic properties for the lidar systems to reduce interference from other lidar systems.

27. The method of claim 26, further comprising:
selecting the number of electromagnetic properties to reduce the interference from the other lidar systems.

28. The method of claim 26, further comprising:
changing an orientation of a laser beam emitted by a lidar system in the lidar systems, wherein said changing the orientation reduces interference caused by other laser beams emitted from other lidar systems.

29. The method of claim 26, wherein said changing the number of electromagnetic properties comprises:
changing a number of wavelengths used by a number of the lidar systems to reduce the interference from the other lidar systems.

30. The method of claim 26, wherein said changing the number of electromagnetic properties comprises:
dynamically changing a number of wavelengths used by a number of the lidar systems to reduce the interference from the other lidar systems during operation of the vehicles.

31. The method of claim 26, wherein said changing the number of electromagnetic properties comprises:
changing a polarity of laser beams used by a number of the lidar systems to reduce the interference from the other lidar systems.

32. The method of claim 26, wherein said changing the number of electromagnetic properties comprises:
dynamically changing a polarity of laser beams used by a number of the lidar systems to reduce the interference from the other lidar systems during operation of the vehicles.

33. The method of claim 26, wherein said changing the number of electromagnetic properties comprises:
changing a number of wavelengths used by a number of the lidar systems to reduce the interference from the other lidar systems; and
changing a polarity of the laser beams used by a number of the lidar systems to reduce the interference from the other lidar systems.
